(19) United States
(12) Patent Application Publication
(10) Pub. No.: US 2025/0144753 A1
(43) Pub. Date: May 8, 2025

(54) MOBILE WELDING ROBOT WITH REMOTE CENTER OF MOTION

(71) Applicant: INROTECH A/S, ODENSE SO (DK)

(72) Inventors: THIUSIUS RAJEETH SAVARIMUTHU, ODENSE SO (DK); FLEMMING JORGENSEN, ODENSE SV (DK)

(21) Appl. No.: 18/834,114

(22) PCT Filed: Feb. 16, 2023
(86) PCT No.: PCT/EP2023/053883

§ 371 Date: Jul. 29, 2024

(30) Foreign Application Priority Data
Feb. 17, 2022 (EP) 22157258.9

(51) Int. Cl. B23K 37/02; B23K 9/127

(52) U.S. Cl. CPC B23K 37/0294; B23K 9/127

(57) ABSTRACT

The disclosure regards a welding robot for performing welding operations when engaged by a positioning arm; the welding robot comprising, a robot arm configured for being connected to the positioning arm at a mounting point, a welding gun connected to the robot arm, wherein an at least first remote center of motion is defined by a point on a kinematic chain along the robot arm and the positioning arm. The welding robot is configured to continuously monitor the at least first remote center of motion and a tool center point of the welding gun during operation of the welding gun.

### FIELD OF INVENTION

The present disclosure relates to welding robots, systems and methods for performing welding operations.

### BACKGROUND OF THE INVENTION

Manufacturers around the world are turning to automation to help solve labor shortages, increase productivity and improve the quality of the manufacturing tasks. Accordingly, robotic welding systems are commonly used to provide cost-effective, flexible, and safe automation solutions for a wide range of production tasks.

One of the challenges in robotic welding applications is the provision of the welding equipment to the welding site. Furthermore, in some cases, for example for welding large structures, in addition to the transport, the positioning of the welding equipment can be cumbersome. It takes time and effort to transport large equipment and it is difficult to maintain the welding equipment in a cost effective and efficient manner. Moreover, moving the welding equipment to another workshop may be limited due to the construction provided with the welding equipment.

A further challenge in robotic welding applications is that the construction provided with the welding equipment is generally not stable. Depending on the welding site, the construction may be influenced by the noise and vibration of the environment. The noise and vibration can also be caused by the structures provided in connection with the welding robot. These structures may for example be cranes, lifting devices, levers which are used for transporting and/or positioning of the welding robot. As a result, the welding task cannot be executed accurately. The welding quality therefore decreases significantly.

Thus, there is a need for advanced robotic welding solutions characterized by a high level of automation with enhanced stability and flexibility. Furthermore, the gap in the art extends to robotic welding solutions for construction sites for the welding of large structures. Moreover, a flexible robotic welding solution wherein the manufacturer can fit the welding robot into an existing workshop flow should be developed.

### SUMMARY OF THE INVENTION

Accordingly, it is an object of the present disclosure to overcome the above-mentioned challenges in welding sites.

The present approach solves the above-mentioned drawbacks and provides first of all a welding robot that is able to compensate the undesired movements of a positioning device, such as a mobile crane, used for holding and/or transporting of the welding robot.

The present disclosure relates in a first aspect to a welding robot for performing welding operations when engaged with a positioning arm. The welding robot comprises a robot arm which can be connected to the positioning arm at a mounting point, and a welding gun connected to the robot arm. A key aspect of the present disclosure is that an at least first remote center of motion is defined by a point on a kinematic chain along the robot arm and the positioning arm. Furthermore, the welding robot is configured to continuously monitor the at least first remote center of motion during operation of the welding gun, for example such that displacement of the positioning arm is compensated. Preferably, the welding robot is configured to continuously monitor a tool center point. Advantageously, an undesired displacement of the welding gun is thereby minimized or even removed.

Thus, the present disclosure envisions a welding robot for engaging with a positioning device, such as a positioning arm or a device having a positioning arm, which transports and positions the welding robot in the proximity of the item to be weld. When the welding gun performs a welding operation while the welding robot engages with the positioning arm, it may be very difficult to avoid the undesired movements of the positioning arm. The undesired movements may for example be vibrations, noise or any other environmental factors that affect the stability of the positioning arm. Such undesired movements can be imposed on the welding robot thereby affecting the welding operation adversely.

The present disclosure therefore proposes defining a remote center of motion (RCM). An at least first RCM can be defined on a kinematic chain along the robot arm and the positioning arm. Thus, the RCM can be any point along the kinematic chain of the robot arm and the positioning arm, i.e. the RCM point can be selected freely. It should be noted that, generally the degrees of freedom (DOF) before the RCM is used to compensate the undesired displacement of the RCM and the DOF after the RCM is used to create the task motion. Thus, in a preferred embodiment of the present disclosure, the robot arm engages with the positioning arm at a mounting point. In a further preferred embodiment, the mounting point is the RCM.

Preferably, the welding robot can be configured to measure the movements and/or the vibrations of the positioning arm, as an RCM control loop. This foresees that the welding robot can be configured to measure an undesired displacement of the RCM. Based on the comparison between the measured RCM at a time during the welding operation and the defined at least first RCM, an undesired displacement of the RCM can be calculated. Advantageously, said undesired displacement resulting because of the movements and vibrations of the positioning arm can be compensated. Thus, a great advantage of the present disclosure is that the welding gun can be controlled to minimize the noise and vibration caused by the positioning arm. The present disclosure therefore can provide a flexible welding robot that can engage with a variety of positioning arms while ensuring a high quality weld.

The present disclosure relates in a second aspect to a robotic welding system for executing a welding task. The system comprises:
a positioning device having a positioning arm,
a welding robot comprising,
   at least a first robot arm connected to the positioning arm at a mounting point, and
   a welding gun connected to the robot arm,

wherein an at least first remote center of motion is defined by a point on a kinematic chain along the robot arm and the positioning arm and/or the positioning device, and wherein the system is configured to continuously monitor the at least first remote center of motion during operation of the welding gun such that displacement of the positioning arm and/or the positioning device is compensated to minimize an undesired displacement of the welding gun. Preferably, the welding robot is configured to continuously monitor a tool center point.

An important aspect of the present disclosure is that the welding robot and/or the welding system is configured to continuously monitor the RCM during the welding operation, for example by measuring the coordinates of the RCM during the welding operation.

In a preferred embodiment, the system can be configured to receive sensor input from the positioning device and/or the robot arm to calculate the displacement of the RCM from the defined at least first RCM. Accordingly, an undesired displacement of the RCM can be compensated. Advantageously, the system can be configured to solve an inverse kinematics of the entire system such that the RCM is stable at a given time with respect to a welding task, such as a welded object.

Furthermore, the welding robot can monitor a tool center point, such as the distance from the welding wire to the object. A great advantage of the presently disclosed approach is therefore that both disturbances due to the movements of the positioning arm (and/or the positioning device) and the deflections which may be caused by the welding process itself can be compensated.

The presently disclosed systems and methods can comprise one or more sensors which can acquire data representing both disturbances. For example, an undesired movement of the welding gun can be detected by an arc sensor. The arc sensor can acquire data relating the sum of the positioning errors due to external deflections and internal deflections. The external deflections may be any deflection of the positioning arm and/or the robot arm and/or the positioning device resulting in an undesired movement of the welding gun, thereby deviating the welding gun from a planned welding path. The internal deflections may be any deflections of the welding task (object) resulting in having the welding gun at an undesired position, such as resulting in a change in the distance between the welding gun and the object. Advantageously, the welding robot can be configured to continuously receive arc sensor data during operation of the welding gun such that said sum of the positioning errors can be compensated. The RCM control, such as calculation of the displacement of the RCM and/or the defined at least first RCM, can be used to estimate which part of the errors come from the undesired movements of a positioning device and/or the positioning arm and/or the robot arm, and which part comes from the disturbances in the welding path due to welding task deflections. Consequently, the present approach can ensure an improved weld quality.

Said compensation of noise and vibration, resulting in an undesired movement or deflection as described previously, may be performed by moving the RCM to its defined position, such as to a predefined position of the at least first RCM. Because the positioning arm and/or the positioning device can move the RCM to the desired position, a more stable welding can be achieved. Thus, the present system can be configured such that the RCM can be maintained stable relative to the welding task. In this way, any noise and vibration can be cancelled out before affecting the welding gun.

Advantageously, the present approach can serve many solutions for providing a stable welding operation. While the compensation of any undesired displacement of the RCM can be performed by the positioning device, additionally or alternatively, an undesired displacement of the RCM can be compensated by the robot arm. The welding robot can be configured to solve an inverse kinematics problem such that the welding robot can calculate the required displacement of the positioning arm and/or the robot arm. Accordingly, the positioning arm and/or the robot arm can move to compensate the calculated displacement of the RCM. However, in some cases, the inverse kinematic problem may not provide a solution to an entire compensation of said undesired movement of the RCM. If the undesired movement is larger than the compensation that the robot arm and/or the positioning arm can perform, a largest possible compensation based on the inverse kinematics can be performed. This implies that the RCM cannot be fully kept stable with respect to the welding task. Thus, in an embodiment, the system can be configured to calculate at least a second RCM position during the course of the welding operation. Alternatively, the RCM can be fully compensated at the next instance of time.

Finally, the present disclosure relates in a third aspect to a computer implemented method for controlling a welding system, having a positioning device, a first robot arm connected to the positioning device at a mounting point, and a welding gun connected to the robot arm. The method comprises the steps of:
calculating coordinates of an at least first remote center of motion defined by a point on a kinematic chain along the robot arm and the positioning device,
measuring a displacement, movement and/vibrations of the positioning device with respect to the at least first remote center of motion or to the welding robot,

The method further comprises the steps of controllably moving the positioning device and/or the robot arm such that the displacement of the positioning device is compensated to minimize an undesired displacement of the welding gun.

Thus, the presently disclosed approach can cancel out the vibrations and noise of the positioning device causing undesired movements of the welding gun. As a result, the welding gun can be operated stably following an initially defined welding path.

All in all, the solutions provided by the present disclosure offer several advantages to the traditional solutions as the present approach provides lower cost, less transport of large structures and flexibility to move to different working areas while ensuring an accurate and precise welding operation.

### DESCRIPTION OF THE DRAWINGS

The invention will in the following be described in greater detail with reference to the accompanying drawings:

FIG. 1 shows one embodiment of a robotic welding system.

FIG. 2 shows one embodiment of a welding robot engaging with a positioning arm.

FIG. 3 shows one embodiment of a robotic welding system.

FIG. 4 shows one embodiment of a robotic welding system comprising a mobile carriage.

### DETAILED DESCRIPTION OF THE INVENTION

The presently disclosed welding robot and the welding system can cancel out any undesired movement of the welding gun, which may happen because of the movements and/or vibrations of the positioning arm and/or the positioning device. Advantageously, the present approach provides solutions for improving the accuracy and precision of a welding operation. In general, the compensation to minimize an undesired displacement of the welding gun can be through stabilizing the RCM at a given time instant.

Generally, an RCM can be a point with or without a physical revolute joint over there, around which a mechanism or a part of the mechanism can rotate. Any point or a sphere that is in angular reach of the system can be defined as the pivoting point of an end effector or an attached tool. The RCM as described herein can preferably be a virtual remote center of motion. Thus, from one aspect, the mounting point or the point or the sphere defined for the RCM may not be mechanically enforced. The RCM may be a virtual point (or a sphere) such that the constraint of fixing a point on the robot arm on a mechanically enforced RCM may be removed. Thus, the robot arm can execute RCM motion without having a physically constrained point. As described herein, RCM may refer to the position of the virtual RCM.

In some cases, the welding gun may be stable with respect to the welded object. However, it may be necessary to move the welding gun when welding large objects in order to reach various regions of the object. Advantageously, the virtual RCM can move along the welding task (the welded object) together with the welding robot. Thus, the RCM may be a point or a region that moves along with the welding robot in accordance with a predefined welding path of the welding gun. Thus, it should be noted that the compensation of the displacement of the RCM may be considered as the compensation of the undesired displacement of the RCM at a given time instant.

According to the present disclosure, the movements of the positioning arm and/or the robot arm and/or the RCM and/or the tool center point can be monitored during the welding operation. Thus, the displacement of the positioning arm and/or the robot arm and/or the RCM and/or the tool center point with respect to the welding task at a given time instant can be detected. Consequently, the displacement of the RCM at a given time instant can be detected. The time instant may be an infinitesimal interval in time, wherein the inverse kinematics of the welding robot and/or the welding system is solved. The time instant may be a predefined time interval.

Generally, a displacement, movement and/or vibrations of the positioning device with respect to an at least first remote center of motion or to the welding robot can be measured. Said measurement can be performed by a sensor or a plurality of sensors. The sensors may be position sensors embedded into the positioning arm and/or into the welding robot and/or provided externally. The sensors may be encoders. The sensors may also be a combination of position sensors and encoders. This foresees that with the present approach, the welding robot and/or the system thereof can be configured to receive sensor input from the positioning device and/or from the welding robot.

In an embodiment, the welding robot can comprise at least one sensor for measuring displacement, movement and/or vibrations of the positioning arm.

In an embodiment, the welding robot can comprise at least one sensor for measuring displacement, movement and/or vibrations of the at least first remote center of motion.

In an embodiment, the welding robot can comprise at least one sensor for measuring displacement, movement and/or vibrations of a tool center point.

In an embodiment, the welding system comprises at least one sensor for measuring displacement, movement and/or vibrations of the positioning arm and/or the positioning device.

The at least one sensor may for example be an arc sensor. The arc sensor and sensors for measuring the displacement, movement and/or vibrations of the positioning arm or other parts may be provided separately such that, the external sensors can be used for RCM control and the arc sensor can be used for close-loop control of the task. Advantageously, the arc sensor and sensors (such as external sensors) for measuring the displacement, movement and/or vibrations of the positioning arm or other parts may be provided in combination.

In an embodiment, the welding robot and/or the welding system comprises at least one arc sensor for measuring a set of welding process parameters of the welding operation. In a further embodiment, the set of welding process parameters is welding current and/or arc voltage. During welding, the resistance between a welding filler and the object can change, when for example the distance between the welding filler and the object changes. Thus, measuring the welding process parameters can be an indication of any changes in the welding path.

The arc sensor can collect data indicating the current levels of the welding gun. The current level can chance as a function of resistance. The resistance can therefore be an indirect measure of the distance from the welding wire to the item. This implies that the welding gun can monitor the tool center point by using an arc sensor measuring the resistance during welding.

The arc sensor can be any sensor detecting changes in the tool center point or in the welding path. These changes can occur due to at least two different sources such as internal and external. Internal process changes can for example be any changes that is caused by the welding process. For example due to the heat up of the object, the object that is being welded can bend, sink or deform relative to the initial geometry. Thus, said distance between the welding filler and the object can change due to material deflection of the object subjected to high heat due to the welding process. These internal changes can be detected by the arc sensor and a compensation motion can be calculated.

External process changes occur due to an offset of the actual welding path relative to the planned path, for example due to change of tools after planning and actual welding. External process changes can also occur due to disturbances from the environment e.g. vibrations from the motion of the robot arm and/or unstable positioning device and so on. These external changes can be detected by the arc sensor and a compensation motion can be calculated. This can be done by combining the arc sensor with the RCM control. The combination of the sensor data measuring the changes of the RCM and the sensor data of the arc sensor, the present approach can calculate which part of the overall position and orientation error comes from the internal and which part comes from the external process changes.

Advantageously, the arc sensor can provide data in a form such that the welding gun position can be controlled. In general, arc sensor data can serve to calculate and correct the distance of the welding gun to the object. The presently disclosed system can be configured such that said distance can be maintained during welding process. In order to do so, the welding robot can be configured to receive arc sensor data representing a plurality of measurements of the set of welding process parameters. In an embodiment, the welding robot is configured to continuously monitor the welding process parameters during operation of the welding gun such that a tool center point is maintained along a predefined welding path. This may for example be performed by a robot controller which can save a correction data that can be used for path planning.

Generally, a kinematic chain comprises the positioning device and the welding robot. On this combined chain, an RCM can act as a stability point. The number of DOF at the point of RCM can preferably be high enough to handle the disturbances that needs to be compensated. The arc sensor can be used to as an in-process sensor to sense changes in the welding process and/or the offsets in the distances between the welding gun and the object. Other sources of disturbances can be sensed by other sensors placed on the positioning device. In an embodiment, the present approach comprises the step of measuring welding process parameters, such as welding current. Preferably, the arc sensor can monitor the current levels of the welding gun. The positioning device and/or the robot arm can be moved such that the welding process parameters, such as the welding current, is maintained within a predefined range.

For example, the calculations and compensations across the width of the groove can be done by detecting the current level while pendling the welding gun back and forth. If the current level is higher on one side compared to the other side of the groove, the tool center position is moved towards the low side. The calculations and compensation in the z-direction (along the groove extension direction) can be done in the following way: If the average current level across the width of the groove is below a set threshold, the tool center point can be moved towards the object. If the average current is above a set threshold the tool center point can be moved away from the item.

Thus, the sensor input can be used for calculating the displacement of the RCM and the tool center point. As used herein, the tool center point refers to a point, sphere or a region used to create necessary adjustments by keeping track of the welding gun. The tool center point can be defined for each welding gun. The tool center point can be the working point of the welding gun and can be used to determine the robot arm's and/or welding gun's positional coordinates.

An accurate tool center point is extremely important for keeping the robotic arm accurate in its movements. An inaccurate tool center point can cause the robotic arm to follow a different welding path than the original planned one. Inaccuracy can also damage the welding robot or the object being welded. In a preferred embodiment, the welding robot is configured to execute a welding task. Accordingly, a welding path for executing the welding task can be defined in terms of the coordinates of the tool center point. This implies that the tool center point can follow a predefined welding path.

Advantageously, the noise and vibration resulted at least from the positioning device and/or the positioning arm can be compensated at the tool center point by moving the tool center point.

In an embodiment, the welding system can be configured to calculate a relative displacement of the positioning arm and/or the positioning device relative to the welding robot, for example relative to the tool center point of the welding robot. In a further embodiment, the system can be configured to displace the positioning device and/or the positioning arm and/or the robot arm such that a tool center point of the robot arm is maintained. Similarly, in an embodiment, the welding robot can be configured to calculate the displacement of the tool center point of the welding robot from a predefined tool center point. In a further embodiment, the welding robot can be configured such that the robot arm moves to compensate the displacement of the tool center point.

In a preferred embodiment, the noise and vibration resulted at least from the positioning device and/or the positioning arm can be compensated at the RCM. Thus, the presently disclosed system can offer a unique solution to the problem of prevention of the misplacement of the welding gun under the vibration and noises resulting from a positioning arm by monitoring the RCM. The monitoring of the RCM may be monitoring a point of the RCM. In an embodiment, a monitoring point of the at least first remote center of motion is the mounting point of the robot arm to the positioning device.

Advantageously, the at least first RCM can be maintained stable with respect to the tool center point and/or the welding task at a given time instant during the welding operation. While the RCM may have a passive coupling such that the RCM may be maintained stable partly due to the damping parts, in a preferred embodiment of the present disclosure an inverse kinematic problem is solved.

In order to solve the inverse kinematic problem, a general RCM constraint can be formalized. For a generic task, the present approach can derive a constrained kinematic controller for exponential convergence of the task with stable satisfaction of the RCM constraint. The kinematic task controller can provide a local convergence in the presence of parameter uncertainties. Additional stability and robustness analysis specific to the considered application may be applied. In general, the proposed inverse kinematic problem solution may follow a similar approach as in the context of minimally invasive robotic surgery, as disclosed by N. Aghakhani et al., in the proceedings of the IEEE International Conference on Robotics and Automation in 2013. Accordingly, the RCM constraint can be formalized for being used in combination with other tasks for control design.

Thus, in an embodiment, the robotic welding system can be configured to calculate a displacement of the at least first RCM. In an embodiment, the system can be configured to compensate a displacement of the positioning device and/or the positioning arm such that the at least first remote center of motion is maintained. In a further embodiment, the system can be configured to move the positioning device and/or the positioning arm for compensating the calculated displacement of the at least first remote center of motion. Alternatively or additionally, the welding robot can be configured such that the robot arm can move to compensate the displacement of the at least first RCM.

The inverse kinematics of the welding system can be solved to calculate the necessary movement of the RCM to be able to keep the RCM stable with respect to the welding task at a given time instant. The robotic system can further be configured to solve the inverse kinematics problem such that the system determines how to maintain the RCM stable. Thus, the system can calculate the degrees of freedom of the robot arm and the positioning arm and analyse how the RCM can be maintained stable most optimal. The analysis for finding an optimal solution may be based on various factors such as cost, speed and capability of the movement. Consequently, the system can propose a solution. In some cases, the system can move the robot arm, in some cases the system can move the positioning arm to compensate the displacement of the RCM. In some cases, the movement of any of the components of the system may not be sufficient to compensate the undesired movement of the RCM. In such a case, the compensation can be performed to the extent that the RCM gets as close as possible to the stabilization point. Thus, the initially defined RCM point, such as the at least first RCM can change. In an embodiment, the system can be configured to calculate at least a second RCM during the course of the welding operation. This foresees that, in an embodiment, the RCM can vary for a predefined welding task. The system can be configured to fully compensate the undesired displacement during the course of the next time instant.

Thus, it may be necessary to define (calculate) an updated RCM. In an embodiment, the system can be configured to calculate at least a second remote center of motion. In an embodiment, the welding robot can be configured such that an at least second remote center of motion is defined. In a further embodiment, the welding robot can be configured to continuously monitor the at least second remote center of motion during operation of the welding gun such that displacement of the positioning arm is compensated to minimize an undesired displacement of the welding gun. In an embodiment, the robot arm and/or the positioning arm moves to compensate the displacement of the at least second remote center of motion. Preferably, the system can be configured to calculate a plurality of remote center of motion during the welding operation.

During the welding operation the compensation can be performed by the positioning arm and the robot arm interchangeably. This foresees that initially an at least first RCM may be stable with respect to the welding task until said at least first RCM is re-calculated and replaced by an at least second RCM.

Moreover, the present disclosure can provide an advanced technology combining the transport and the positioning of a welding equipment with the operation of the welding equipment.

In an embodiment, the positioning device is a mobile device such as a mobile crane. Thus, the welding robot can be transported and positioned with minimum effort. The mobile crane may for example be a gantry crane. Advantageously, the dimensions of the gantry such as the width of the gantry can be tailor-made to meet the customer's requirements for the specific welding task. Due to the set-up of the presently disclosed system comprising a mobile positioning device, the welding operation can be performed while moving the welding robot with the mobile crane. In an embodiment, the robotic welding system further comprises a mobile carriage configured for carrying and/or positioning the welding robot. This foresees that the positioning device may comprise a mobile carrier, such as a trolley unit, that carries and moves the positioning arm.

Alternatively or additionally, the positioning device can be a device comprising a robot arm. Thus, in an embodiment, the positioning arm is at least a second robot arm. As used herein, the robot arm refers to a mechanical arm or a mechanical structure, which can move linearly and/or rotationally. A robot arm may be the sum total of the mechanism or may be part of a more complex robot.

In an advantageous embodiment, the welding task has a pre-defined frequency, such as 1 Hz or more, preferably between 3-10 Hz, more preferably between 2-4 Hz. In an embodiment, a sampling frequency of the at least one sensor corresponds to the welding task frequency. In an embodiment, a sampling frequency of the at least one sensor and/or the at least one arc sensor is 1000 Hz or more. An advantage of coordinating the sampling frequency with the frequency of the welding task may be to identify the undesired movements so frequent that an undesired movement which may affect the tool center point can be compensated. Furthermore, by the present approach, the inverse kinematics may be solved for a time interval in accordance with the sampling frequency. Moreover, the welding gun oscillates during welding, which can be referred as weaving during welding. Advantageously, the arc sensor can acquire data in accordance with the weaving frequency such that at least one data point can be acquired during welding. The weaving frequency can for example be between 3-10 Hz.

Advantageously, the present disclosure relates to a computer implemented method for controlling a welding system comprising a positioning device, a first robot arm connected to the positioning device at a mounting point, and a welding gun connected to the robot arm. The welding gun can be connected to the robot arm such that the welding gun is responsive to movement of the robot arm.

According to the present disclosure, the coordinates of an at least first remote center of motion which is defined by a point on a kinematic chain along the robot arm and the positioning device is calculated. Furthermore, displacement, movement and/or vibrations of the positioning device with respect to the at least first remote center of motion or to the welding robot can be measured. The method can solve an inverse kinematics problem such that the movement of the positioning arm and/or the robot arm for compensating the undesired movement of the RCM can be calculated. Then the positioning device and/or the robot arm can move controllably. Consequently, the displacement of the positioning device can be compensated to minimize an undesired displacement of the welding gun and/or the RCM.

In an embodiment, the present disclosure further comprises the step of calculating the displacement of the at least first remote center of motion. In a further embodiment of the present disclosure, the method further comprises the step of compensating the displacement of the at least first remote center of motion such that the at least first remote center of motion is stable during the operation of the welding gun. This may be performed by moving the positioning device and/or positioning arm.

Alternatively, in an embodiment, the present approach comprises the step of moving the robot arm such that a tool center point of the welding gun and/or the RCM is stable during the operation of the welding gun.

In an embodiment, the present approach comprises the step of moving the positioning device and/or the robot arm such that an undesired displacement of the at least first remote center of motion is compensated.

In an embodiment, the present approach comprises the step of moving the positioning device and/or the robot arm such that an undesired displacement of the at least first remote center of motion is compensated partially.

The distance of the remote center of motion to the tool center point can be maintained constant during the operation of the welding gun. This foresees that the present approach can be configured for maintaining the at least first remote center of motion during the operation of the welding gun.

Depending on the compensation strategy and the capabilities of the system, such as available degree of freedoms, the compensation may not be fulfilled entirely. In an embodiment, the method comprises the step of calculating an at least second remote center of motion based on the displacement, movement and/vibrations of the positioning device and/or the robot arm.

In an embodiment of the present method, a stable welding operation is provided by means of a welding robot according to any one of the above described embodiments.

In an advantageous embodiment, a stable welding operation is provided by means of a robotic welding system according to any one of the above described robotic welding systems.

### DETAILED DESCRIPTION OF THE DRAWINGS

The present disclosure will now be described more fully hereinafter with reference to the accompanying exemplary embodiments shown in the drawings when applicable. However, it is to be noted that the presently disclosed system and method may be embodied in various forms. The hereby provided embodiments are to guide a thorough and complete disclosure. Hence, embodiments set forth herein should not be interpreted as limiting but be construed as a tool for delivering the scope of the invention to those who are skilled in the art. Same reference numbers refers to the same element throughout the document.

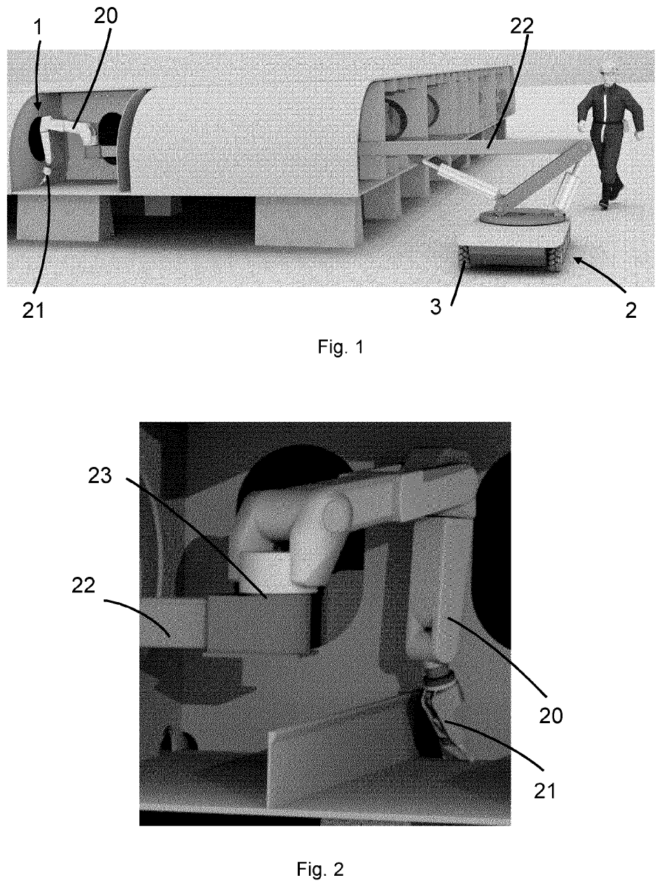

FIG. 1 shows one embodiment of a robotic welding system according to the presently disclosed approach. The robotic welding system comprises a positioning device 2 having a positioning arm 22. According to the example shown in FIG. 1, the positioning device is a mobile crane 2 having conveyor wheels 3 through which the positioning device can travel. The mobile crane 2 transports and positions the multi-dof welding robot 1 in the proximity of the item to be weld.

The positioning arm 22 engages a welding robot 1. The welding robot 1 comprises a robot arm 20 connected to the positioning arm 22 and a welding gun 21 is connected to the robot arm 20.

As shown in FIG. 2, the robot arm 20 is connected to the positioning arm 22 at a robot arm base 23. The mounting point of the robot arm base 23 to the positioning arm 22 is defined as a virtual RCM control point. The movements, the vibrations of the mobile crane 2 are measured by position sensors and cameras (not shown). The system is configured to continuously monitor and control the first defined virtual RCM during operation of the welding gun 21. The monitoring and controlling of the virtual RCM point is based on sensor input from the mobile crane 2. The system is configured to calculate displacement of the virtual RCM point from the desired placement. Accordingly, the positioning arm 22 and/or the robot arm 20 can move to compensate the movements and the vibrations of the mobile crane 2. The control of the virtual RCM point to maintain its desired placement can be performed by moving the positioning arm 22. Alternatively or additionally, the robot arm 20 can move to keep the welding task stable.

The welding gun 21 can be equipped with an arc sensor (not shown), wherein the arc sensor can measure welding process parameters, such as welding current and/or arc voltage. These parameters may change when the welding gun distance to the object changes, which can change based in internal and external process disruptions. The arc sensor can provide data in a form such that the welding gun 21 position can be controlled such that a tool center point is maintained along a predefined welding path. The combination of the sensor data measuring the changes of the RCM and the sensor data of the arc sensor, makes it possible to identify different error sources. The arc sensor may be positioned closer to the target (welding) area and the external sensors may be configured such that external displacements can be measured.

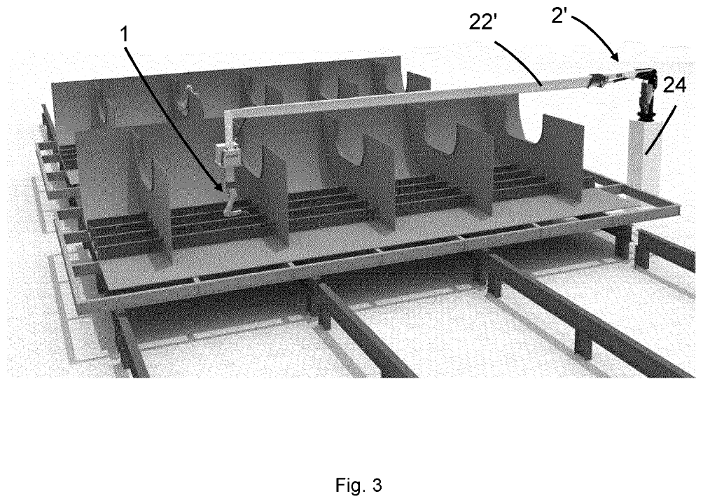

FIG. 3 shows another embodiment of a robotic welding system. According to this embodiment, the positioning device 2′ has a stable base 24. The positioning device comprises a mobile arm 22′ for moving the welding robot 1 to the proximity of the welding operation. Accordingly, the welding operation can be performed while moving the welding robot 1 and/or the mobile arm 22′.

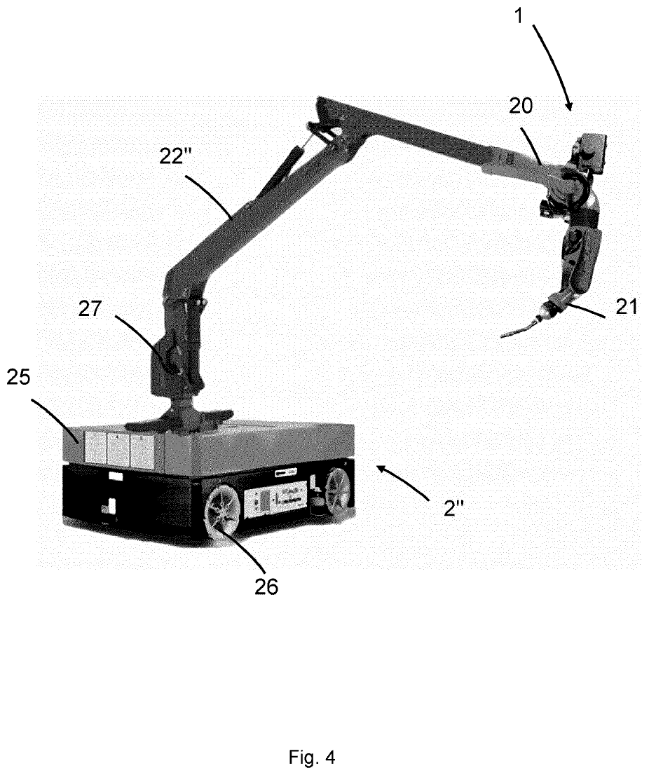

In such a large workspace, it may be necessary to provide mobile platforms and cranes for positioning and lifting necessary equipment. FIG. 4 shows an embodiment of a robotic welding system comprising a mobile positioning device 2″. The mobile positioning device 2″ comprises a positioning arm 22″ and a mobile carriage base 25. The mobile carriage base 25 can move on wheels 26 and can carry and move various types of positioning arms. The mobile carriage base 25 is provided with a connector link 27 on top. The connector link 27 is connected to the positioning arm 22″. The positioning arm 22″ engages with the connector link 27 at one end and with the welding robot 1 at an other end. Advantageously, the dimensions of the mobile positioning device 2″ can be tailor-made to meet the customer's requirements for the specific welding task. The RCM can be selected freely anywhere along the kinematic chain of the robotic welding system comprising a mobile positioning device. For example, the RCM may be where the robot arm 20 is connected to the positioning arm 22″. The RCM may be where the positioning arm 22″ is connected to the connector link 27. The RCM may be where the connector link 27 is connected to the carriage base 25.

The proposed welding robot and/or the welding system can be used in the energy sector for smart robot welding of offshore structures, such as for crawler-based welding of monopiles. The proposed approach can be further used in maritime sector for hyper robotized shipbuilding. Additionally, construction sector can make use of the present disclosure. For example in robotized construction operations, such as processes around concrete, insulation and cladding, the proposed welding robot and the welding system can be provided. Moreover, the energy sector can utilize the hereby presented 10 disclosure, for example for robotized nacelle assembly or robotized composite production.

1. A welding robot for performing welding operations when engaged by a positioning arm; the welding robot comprising,
a robot arm configured for being connected to the positioning arm at a mounting point,
a welding gun connected to the robot arm,
wherein an at least first remote center of motion is defined by a point on a kinematic chain along the robot arm and the positioning arm, and
wherein the welding robot is configured to continuously monitor the at least first remote center of motion and a tool center point during operation of the welding gun such that displacement of the positioning arm is compensated to minimize an undesired displacement of the welding gun.

2. The welding robot according to claim 1, further comprising at least one sensor for measuring displacement, movement and/or vibrations of the positioning arm.

3. The welding robot according to claim 1, further comprising at least one sensor for measuring displacement, movement and/or vibrations of the at least first remote center of motion.

4. The welding robot according to claim 1, further comprising at least one sensor for measuring displacement, movement and/or vibrations of the tool center point of the welding gun.

5. The welding robot according to claim 1, further comprising at least one arc sensor for measuring a set of welding process parameters of the welding operation.

6. (canceled)

7. The welding robot according to claim 2, wherein a sampling frequency of the at least one sensor is 1000 Hz or more.

8. The welding robot according to claim 1, wherein the welding robot is configured to continuously monitor the welding process parameters during operation of the welding gun such that the tool center point is maintained along a predefined welding path.

9. The welding robot according to claim 1, configured to calculate the displacement of the tool center point of the robot arm from a predefined tool center point.

10. The welding robot according to claim 1, wherein the welding robot is configured such that the robot arm moves to compensate the displacement of the tool center point.

11. The welding robot according to claim 1, wherein a monitoring point of the at least first remote center of motion is the mounting point of the robot arm to the positioning device.

12. The welding robot according to claim 1, wherein the welding robot is configured such that the robot arm and/or the positioning arm moves to compensate the displacement of the at least first remote center of motion.

13. The welding robot according to claim 1, configured such that an at least second remote center of motion is defined.

14. The welding robot according to claim 13, configured such that the robot arm and/or the positioning arm moves to compensate the displacement of the at least second remote center of motion.

15. (canceled)

16. (canceled)

17. (canceled)

18. A robotic welding system for executing a welding task, the system comprising: a positioning device having a positioning arm;
a welding robot for performing welding operations when engaged by the positioning arm, the welding robot comprising,
a robot arm configured for being connected to the positioning arm at a mounting point,
a welding gun connected to the robot arm,
wherein an at least first remote center of motion is defined by a point on a kinematic chain along the robot arm and the positioning arm, and
wherein the system is configured to continuously monitor the at least first remote center of motion and the tool center point during operation of the welding gun such that displacement of the positioning arm and/or the positioning device is compensated to minimize an undesired displacement of the welding gun.

19. The system according to claim 18, configured to calculate a displacement of the at least first remote center of motion, wherein the system is configured to move the positioning device and/or the positioning arm and/or the robot arm for compensating the calculated displacement of the at least first remote center of motion.

20. (canceled)

21. The system according to claim 18, further comprising at least one sensor for measuring displacement, movement and/or vibrations of the positioning arm and/or the positioning device, wherein the system is configured to compensate a displacement of the positioning device and/or the positioning arm such that the at least first remote center of motion is maintained.

22. (canceled)

23. The system according to claim 18, wherein the system is configured to displace the positioning device and/or the positioning arm and/or the robot arm such that a predefined tool center point of the robot arm is maintained.

24. The system according to claim 18, wherein the system is configured to calculate at least a second remote center of motion.

25. The system according to claim 18, configured to calculate a relative displacement of the positioning arm and/or the positioning device relative to the welding robot.

26. (canceled)

27. (canceled)

28. (canceled)

29. A computer implemented method for controlling a welding system, having a positioning device, a first robot arm connected to the positioning device at a
mounting point, and a welding gun connected to the robot arm, the method comprises the steps of:
calculating coordinates of an at least first remote center of motion defined by a point on a kinematic chain along the robot arm and the positioning device,
measuring a displacement, movement and/vibrations of the positioning device with respect to the at least first remote center of motion or to the welding robot, and
controllably moving the positioning device and/or the robot arm such that the displacement of the positioning device is compensated to minimize an undesired displacement of the welding gun.

30. (canceled)

31. (canceled)

32. (canceled)

33. (canceled)

34. (canceled)

35. (canceled)

36. (canceled)

37. (canceled)

38. (canceled)
